(19) United States
(12) Patent Application Publication
(10) Pub. No.: US 2010/0322471 A1
(43) Pub. Date: Dec. 23, 2010

(54) Motion invariant generalized hyperspectral targeting and identification methodology and apparatus therefor

(75) Inventors: Patrick J. Treado, Pittsburgh, PA (US); Jason H. Neiss, Pittsburgh, PA (US)

Correspondence Address: CHEMIMAGE CORPORATION, 7301 PENN AVENUE, PITTSBURGH, PA, 15208, US

(73) Assignee: CHEMIMAGE CORPORATION, Pittsburgh, PA (US)

(21) Appl. No.: 11/544,727

(22) Filed: Oct. 10, 2006

Related U.S. Application Data
(60) Provisional application No. 60/724,575, filed on Oct. 7, 2005.

(51) Int. Cl. G06T 7/00

(52) U.S. Cl. 382/103

(57) ABSTRACT

The present disclosure relates to a method and system for enhancing the ability of nuclear, chemical, and biological (“NBC”) sensors, specifically mobile sensors, to detect, analyze, and identify NBC agents on a surface, in an aerosol, in a vapor cloud, or other similar environment. Embodiments include the use of a two-stage approach including targeting and identification of a contaminant. Spectral imaging sensors may be used for both wide-field detection (e.g., for scene classification) and narrow-field identification.

### RELATED APPLICATIONS

The present application hereby incorporates by reference in its entirety and claims priority benefit from U.S. Provisional Patent Application Ser. No. 60/724,575 filed 7 Oct. 2005.

### BACKGROUND

There is a need to detect nuclear, biological, and chemical (“NBC”) agents in the air and on surfaces. Some of these agents my render a surface, area, or volume of space inhospitable for human activity. Therefore, there is a need to have a remote-control reconnaissance system survey and/or analyze the surface/area/volume or area while minimizing any deleterious effects on humans. Current NBC reconnaissance/analysis systems, hereinafter sometimes referred to as “NBC Recon Systems”, use a double wheel sampling system and a mobile mass spectrometer to detect contamination. However, current reconnaissance systems suffer the drawback of either needing to be stationary in order to obtain an analysis or accept a degraded analysis due to the motion of the reconnaissance system.

Nuclear agents generally pose the threat of gamma ray, alpha particle, beta particle, or other forms of radiation from nuclear or radioactive decay, either from an external source or an internal source if ingested or respirated into one's body. Chemical agents can be one or more of a wide variety of chemical elements or compounds that are hazardous to humans. Biothreat agents exist in four forms: agents such as anthrax are bacterial spores. Other biothreat agents exist as a vegetative (live) cell such as plague (Yersinia pestis). Another class of biothreat agents includes the virus responsible for diseases such as smallpox and Ebola. A further type of biothreat agent includes toxins, chemicals produced by a specific organism that are toxic to humans, such as Ricin and botulism toxin. While these are technically chemical agents since they do not involve a living or dormant organism, they are typically considered as biothreat agents.

A practical NBC Recon System must be able to identify as many different types of agents as possible. Ideally, it should cover agents in each of the four biothreat groups, as well as nuclear and chemical agents and should do so without the operator having any prior knowledge of which agent or agents is/are present. A practical detector should preferably identify the presence of an agent in the presence of all of the other materials and chemicals present in the normal ambient environment. These materials and chemicals include dusts, pollen, combustion by-products, tobacco smoke, and other residues, as well as organisms normally present in, for instance, water, air, and soil. This detection specificity is desirable to avoid a false positive that can elevate a hoax into an apparent full-blown disaster, such as from a weapon of mass destruction.

As stated above, current NBC Recon Systems are limited in their ability to detect, analyze, and identify NBC agents due in part to the need to be stationary in order to perform their analysis. Therefore, a need exists to allow an NBC Recon System to detect, analyze, and identify NBC agents while the NBC Recon System in motion. Consequently, a Motion Invariant Generalized Hyperspectral Targeting and Identification (“MIGHTI”) methodology and system has been developed and will be disclosed in detail further below. The MIGHTI methodology and system operates to enhance the ability of NBC Recon Systems to perform their important tasks. Accordingly, it is an object of the present disclosure to provide a method for identifying threat agents including scanning a threat area using a wide-field sensor attached to a moving object to thereby identify a location having a threat agent, scanning the location using a narrow-field sensor attached to the moving object to thereby produce a signal, providing the signal to an identification algorithm, and identifying the threat agent using the identification algorithm. Furthermore, the identification algorithm may perform pixel averaging, adaptive subspace detection, and voting logic.

It is another object of the present disclosure to provide a system for identifying threat agents, which may include a first sensor attached to a moving object where the first sensor scans a threat area to thereby identify a location having a threat agent, a second sensor attached to the moving object where the second sensor scans the location to thereby produce a signal, and a processor programmed to run an identification algorithm, where the processor receives the signal and identifies the threat agent from the signal. Furthermore, the identification algorithm may perform pixel averaging, adaptive subspace detection, and voting logic.

### BRIEF DESCRIPTION OF THE DRAWINGS

FIG. 1 is a block diagram illustrating a methodology used in one embodiment of the disclosure.

FIG. 2 is a pictorial and graphical representation of targeting and identification results according to one embodiment of the disclosure.

FIG. 3 is a pictorial and graphical representation of the use of an Adaptive Subspace Detector according to one embodiment of the disclosure.

FIG. 4 is a pictorial and graphical representation of a specific use of targeting of a biothreat agent using optical and fluorescence imaging according to one embodiment of the disclosure.

FIG. 5 is a pictorial and graphical representation of motion tracking of a water vapor plume according to one embodiment of the disclosure.

FIG. 6 is a pictorial representation of motion correction in hyperspectral imagery according to one embodiment of the disclosure.

FIG. 7 is a graphical representation of the reduction of false alarm conditions due to the application of voting logic and imaging according to one embodiment of the disclosure.

FIG. 8 is a block diagram illustrating the application of an identification algorithm according to one embodiment of the disclosure.

FIG. 9 is a pictorial representation of detection of Bacillus globigii (“BG”) spores amidst Escherichia coli (“E. coli”) using the Adaptive Subspace Detector according to one embodiment of the disclosure.

FIG. 10 is a graphical representation of the application of voting logic to the results shown in FIG. 5 according to one embodiment of the disclosure.

FIG. 11 is a pictorial and graphical representation of the use of Multivariate Curve Resolution (“MCR”) according to one embodiment of the disclosure.

### DETAILED DESCRIPTION

The present disclosure relates to a method and system for enhancing the ability of NBC Recon Systems, and other similar systems, to detect, analyze, and identify NBC agents. These agents may be, for example, on a surface, in an aerosol, in a vapor cloud, or other similar environment. A software tool kit may be used to enhance an NBC Recon System. The software tool kit may include algorithms for imaging systems in a standoff detection mode. A two-stage detection methodology, such as targeting and identification, and system therefor may be implemented that will leverage spectral imaging sensors in both wide-field detection (e.g., for scene classification) and narrow-field identification. The information from both the wide-field and the narrow-field modes may be combined and presented to an operator, preferably stationed remotely from the sensors and/or the NBC Recon System. Additionally, an Adaptive Subspace Detector (“ASD”) may be used for identification of NBC agents in multivariate backgrounds and/or for the detection of NBC aerosols or and/or vapor clouds using, for example, Raman dispersive spectroscopy. Furthermore, the ASD may be applied to multipixel images. Stand-off detection and identification of NBC contamination agents is needed for many instances, such as by war fighters as well as first responders to name two. Rapid response from the sensors, especially while in motion, is vitally important. In order to achieve these goals, wide-field and narrow-field sensors need to both be used and integrated in a combined system. Information from both wide-field and narrow-field modes may be combined and presented to an operator, preferably stationed remotely from the sensors and/or the NBC Recon System standoff detection imaging system is mounted on a vehicle to survey the air for chemical or biological agents. The imaging system must be able to acquire wide-field images, locate suspicious areas, and apply its threat identification system, all amidst vehicle motion and a short time-to-detect.

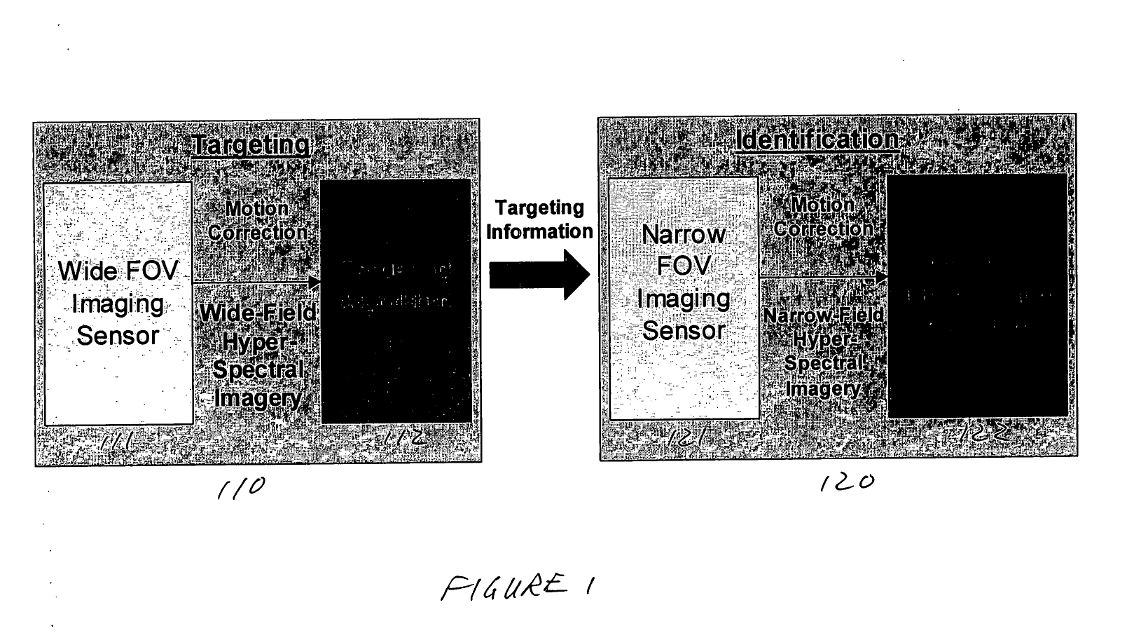

Embodiments of the present disclosure include the use of a Motion Invariant Generalized Hyperspectral Targeting and Identification (“MIGHTI”) software tool kit which may include algorithms for the autonomous identification of chemical and biological threat agents amidst background interference and sensor motion, preferably, but not necessarily, when used with an NBC Recon System. The algorithm may include two concepts of operation: a wide-area hyperspectral imaging stand-off detection system with multiple types of deployed image sensors and a multi-mode chemical and biological hyperspectral imaging surface contamination detection system as shown in FIG. 1. MIGHTI may be realized as a two-stage algorithm that suppresses background and enhances threat concentration thereby reducing false alarms and improving detection probability. FIG. 1 is a block diagram illustrating a methodology used in one embodiment of the disclosure. In the targeting module 110 the wide field of view (“FOV”) imaging sensor 111 may be motion corrected while using wide-field hyperspectral imagery to supply input into a targeting algorithm 112. Targeting information from the targeting algorithm may then be supplied to the identification module 120 where the narrow FO imaging sensor 121 may be motion corrected while using narrow-field spectral imagery to supply input into a detection/identification algorithm 122, which will be discussed in more detail below. The targeting information from the targeting module 110 can be used to direct the narrow FOV imaging sensor 121 to an area of interest, for example.

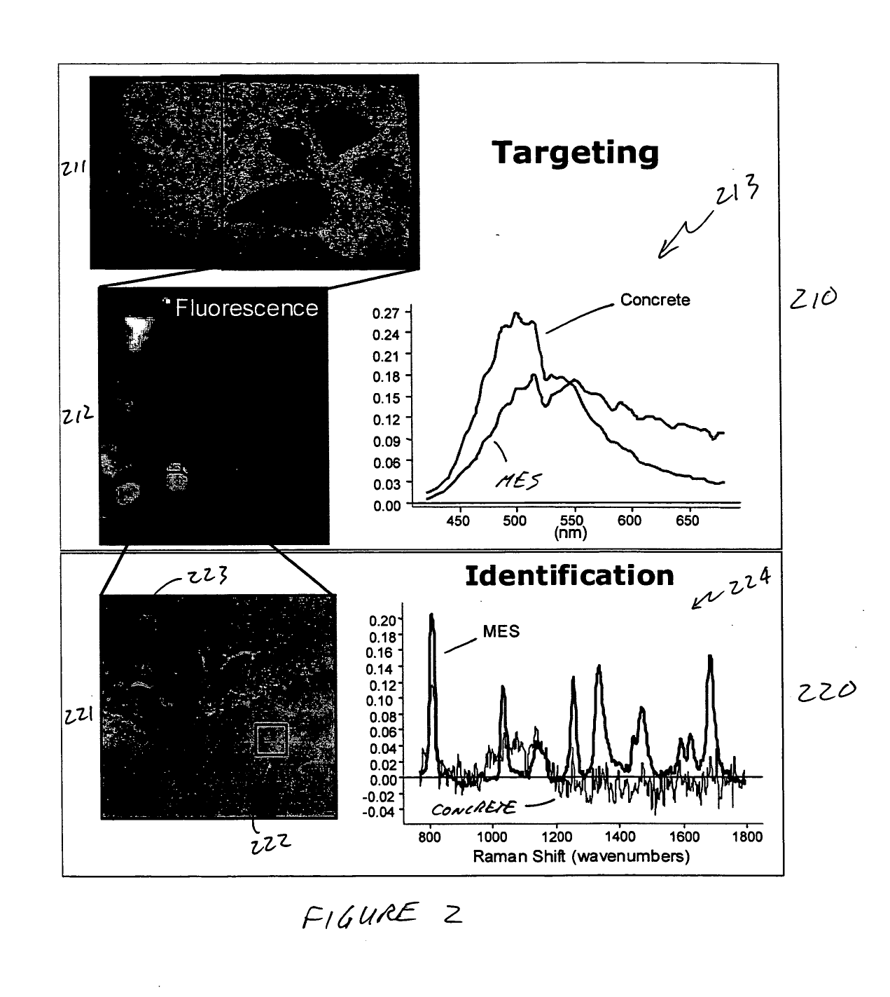

Nuclear, chemical and biological threats are largely microscopic materials that cannot be confidently detected and identified using a macroscopic system alone. Blindly applying a sensor to a macroscopic scene may subject the system to a higher likelihood of false positives than applying the sensor to a region likely to contain threat. Thus using one or more sensors for targeting candidate scene regions and applying a sensitive, specific detector to those regions allows for a reduction in the likelihood of false positives. This coordination allows macro analysis to guide targeted hyperspectral identification. FIG. 2 is a pictorial and graphical representation of targeting and identification results for surface contamination of methyl salicylate (“MES”) on a concrete background, according to one embodiment of the disclosure. Shown in FIG. 2 are exemplary, and non-limiting, results from the use of a two-step approach (i.e., targeting and identification) according to embodiments of the present disclosure. The two-step algorithm used to generate the results shown in FIG. 2 includes: (1) targeting based on optical and fluorescence or near infrared (“NIR”) image feature recognition, and (2) identification based on Raman or NIR hyperspectral image target detection. As is obvious to those of skill in the art, the invention is not limited to this specific embodiment. The results of targeting using an optical sensor are shown in the 211 image. Part of the 211 image is examined further using a fluorescence sensor as shown in the 212 image where the contaminant (in this case, the MES) shows up against the concrete background. The graph 213 depicts an output from the targeting sensors as a graph of intensity (along the y-axis) versus illumination wavelength (along the x-axis) for MES and for the concrete, which is just one possible output. This targeting information can be used as an input into the targeting algorithm 112 in order to “steer” the narrow-field sensor, in this case a Raman sensor, to a particular location on the concrete to identify the contaminant (in this case, the MES). An image 221 from the Raman sensor reveals an area of contamination 222 and an area of no contamination (i.e., the concrete) 223. The graph 224 depicts an output from the identification sensors as a graph of intensity (y-axis) versus Raman shift in wavenumbers (x-axis). As can be readily seen and understood by those of skill in the art, the contaminant has a definite signature and the contaminant can therefore be readily identified by, for example, the detection/identification algorithm 122 by comparing the output of the identification sensor with an exemplary MES signature graph stored in a memory either locally or remotely.

Unlike typical prior art systems where an operator manually prepares samples, introduces them to a sensor, then manually locates a suspicious-looking region or region of interest, the present disclosure automates the procedure to thereby greatly enhance the time to detect and identify a contaminant while decreasing the possibility of generating a false positive result.

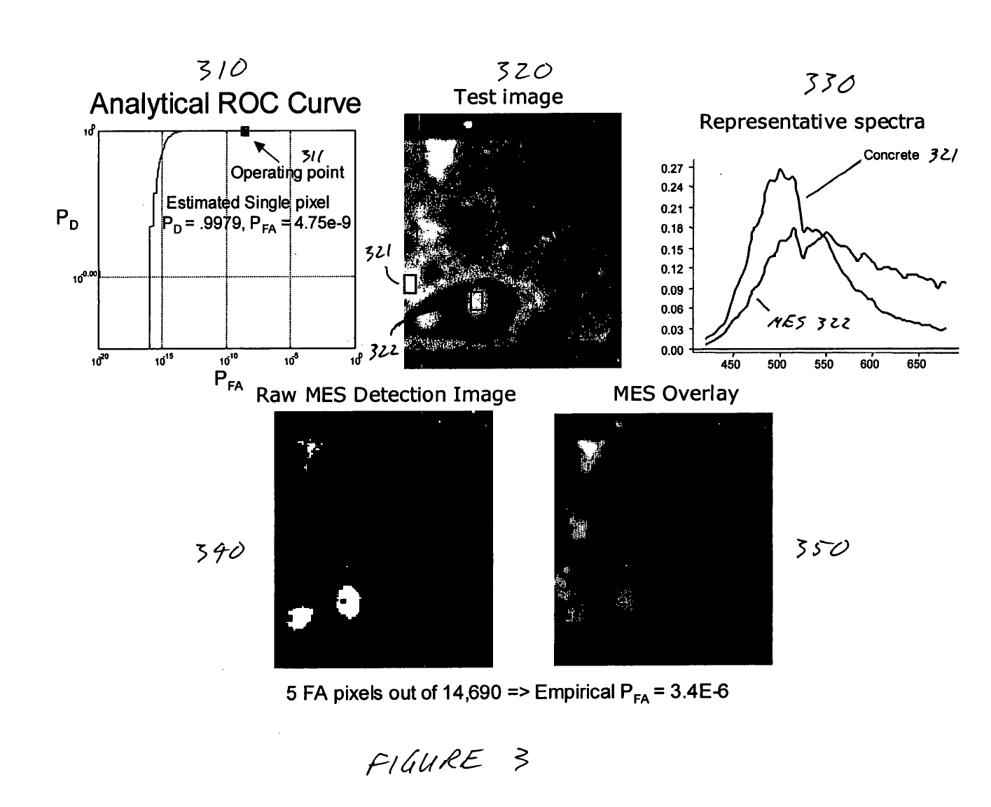

The present disclosure includes image analysis algorithms to automatically locate material and/or regions of interest at successive levels of magnification. This is necessary because narrow-field sensors, such as a Raman sensor, operate best over microscopic fields of view. A wide-field sensor is used to accurately target and guide a narrow-field sensor to high-likelihood regions of interest. This problem becomes more acute, for example, in the case of nuclear, chemical or biological agents which are diffusely spread over a surface where location and identification of one or more contaminants must be accomplished amidst a complex macroscopic scene. FIG. 3 is a pictorial and graphical representation of the use of an Adaptive Subspace Detector (“ASD”) according to one embodiment of the disclosure. In this exemplary, nonlimiting embodiment, the contaminant is MES on a concrete background. A targeting sensor may first acquire a macro optical image of the scene along with a hyperspectral targeting image. The hyperspectral targeting image may be acquired with either fluorescence or NIR, depending on the nuclear, biological, or chemical nature of the presumed threat. A targeting algorithm may then be applied to the hyperspectral image and candidate threat coordinates and presumptive identities may be reported to a local and/or a remote operator. As discussed above, FIG. 3 shows an application of the ASD algorithm to a macrofluorescence image of the chemical threat stimulant Methyl Salicylate (MES) on a concrete background. The MES droplets are clearly detected against the concrete background. An exemplary analytical Receiver Operating Characteristic (“ROC”) curve is shown as the graph 310. The probability of detection (“P_{D}”) is the y-axis and the probability of a false alarm (“P_{FA}”) is the x-axis. A chosen operating point is indicated at 311 where the P_{D} is 0.9979 and the P_{FA} is 4.75e⁻⁹. These are exemplary, nonlimiting values as would be obvious to those of skill in the art. The image 320 is a wide-field macrofluorescence image of the scene (i.e., MES on concrete) on which are indicated an area 321 which is predominantly uncontaminated concrete and an area 322 which is contaminated with MES. The representative spectra of the concrete area 321 and the MES contaminated area 322 are shown in the graph 330, which is intensity (y-axis) versus illuminating wavelength (x-axis). The image 340 is a raw MES detection image and the image 350 is an MES overlay using the ASD, as will be discussed in more detail below. The image 350 demonstrates the utility of the ASD algorithm to detect an MES threat using fluorescence imaging and is useful for targeting a narrow-field sensor, as would be obvious to those of skill in the art.

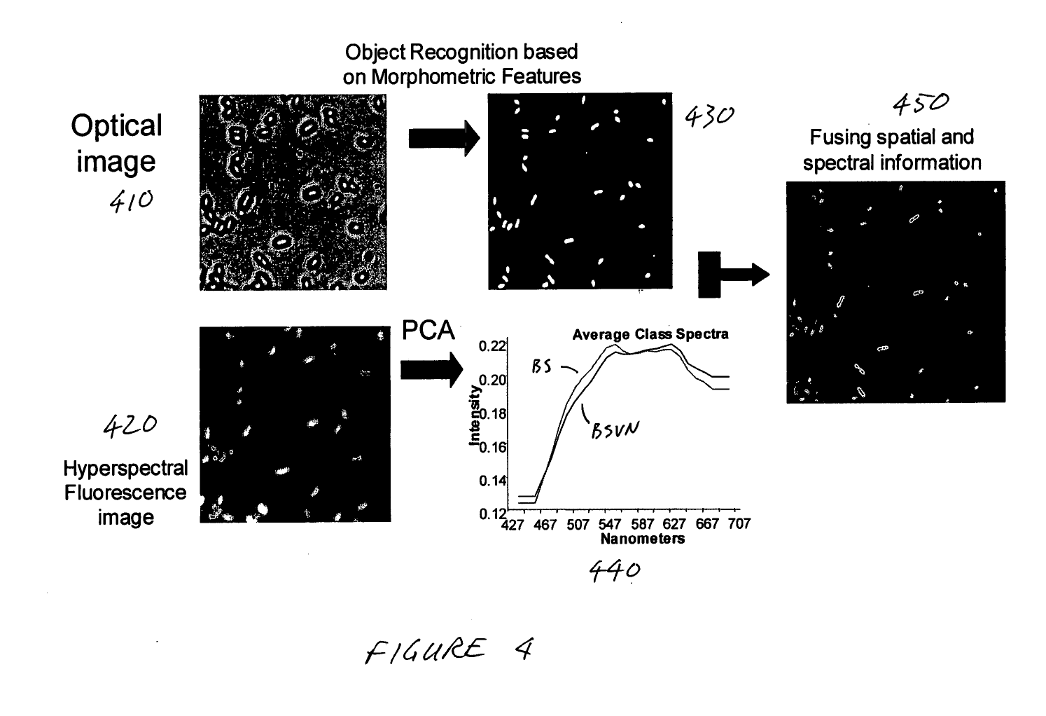

Depending on the spatial resolution of the targeting sensor, additional information can be used to improve detection performance. If any morphological parameters of the desired threats are known (e.g., object size, shape, color, etc.), information from the optical image can supplement that derived from the hyperspectral image. As seen in FIG. 4, object recognition on optical and fluorescence imaging enables masking of important regions and suppression of noisy background regions. The combination of hyperspectral data and spatial statistics from optical images allows targeting of candidate regions. For example, the image 410 is an optical image of a scene containing suspected biological contaminants, in this case Bacillus subtilis var. niger (“BSVN”) and Bacillus stearothermophilus (“BS”). The image 420 is a hyperspectral fluorescence image of the same scene. From the optical image 410, an object recognition procedure can be implemented based on, for example, morphological features of the suspected biological contaminants resulting in the image 430. From the hyperspectral image 420 a principal components analysis (“PCA”) can be performed, the results of which are shown in the graph 440. The results of the morphological features analysis and the PCA analysis may then be combined resulting in the composite image 450 which, as will be recognized by those of skill in the art, is useful in distinguishing the suspected biological contaminants via their different spectral and morphological features and therefore has utility for targeting a narrow-field sensor.

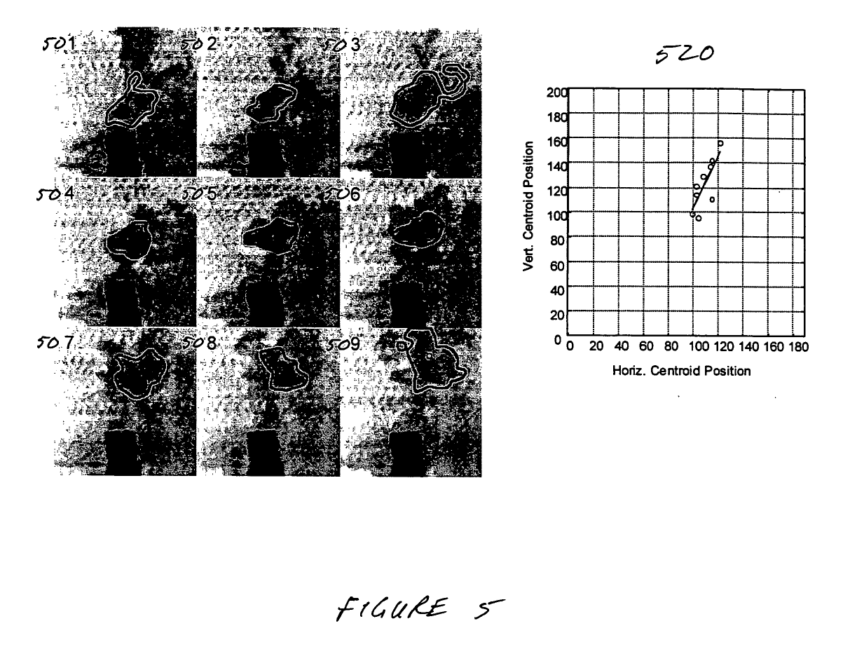

For targeting airborne contaminants, similar object recognition algorithms may be used to locate and track vapor clouds from a variety of sensors. FIG. 5 shows an infrared (“IR”) time sequence of images (images 501 through 509) of rising water vapor. In each image of this scene, the cloud outline is automatically detected, and feature recognition (tracking, trajectory prediction, as non-limiting examples) may be performed on the detected pixels. Furthermore, a centroid of the cloud in each image may be calculated and the centroids plotted as shown in the graph 520 (vertical centroid position on the y-axis and horizontal centroid position on the x-axis). These exemplary, nonlimiting results utilized a bandpass filter at 1450 nm to detect the presence of water vapor. A hyperspectral imager may be used to sweep over the NIR wavelengths thereby producing a wavelength series of images 501-509.

Targeting is also dependent on motion compensation. Two types of motion may affect the identification ability of a hyperspectral-imaging sensor: (1) vibrational sensor motion, and (2) target within-scene motion. These conditions may manifest themselves with similar artifacts in hyperspectral images, such as objects whose relative positions vary between image frames. Hardware components such as inertial camera stabilization systems reduce camera vibration effects, but software algorithms for image registration are useful in hyperspectral imagery. The present disclosure contemplates the use of image frame registration algorithms that may use image correlation to align objects between frames, including the ability to apply warping effects. Image correlation may measure the movement of objects between successive frames, may perform intensity matching to assign movement to objects, and may perform an inverse transform to remove the motion and realign the objects.

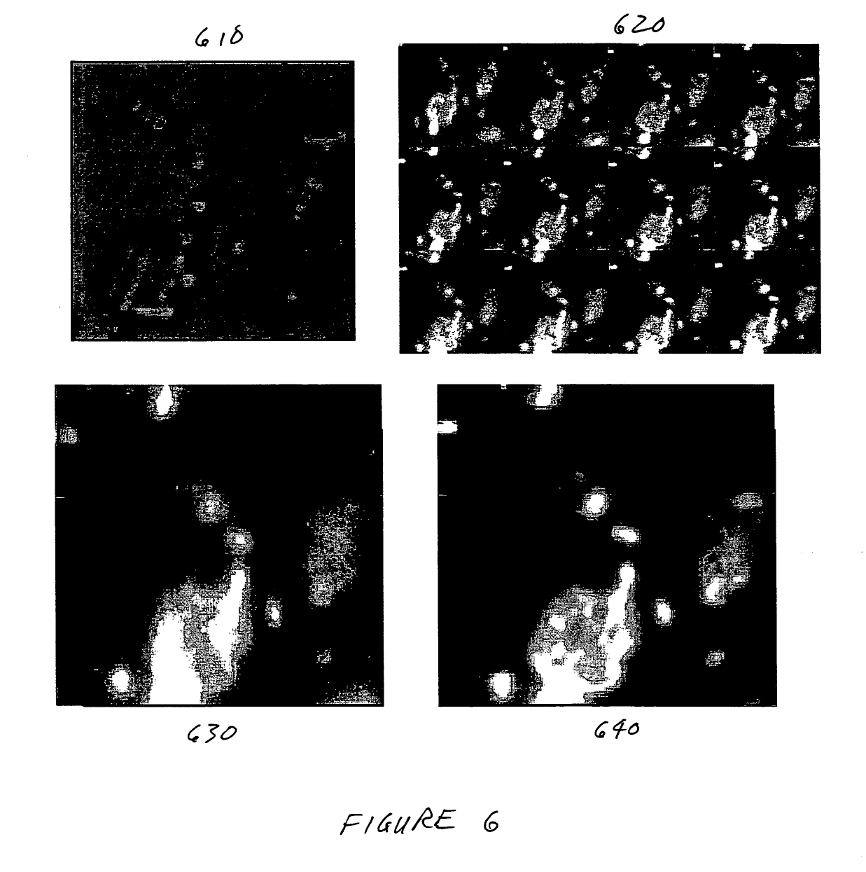

Object motion in hyperspectral imagery may result in pixels containing mixed spectral components, as objects move through pixels. Motion thus degrades spectral fidelity and reduces detection probability. Averaging hyperspectral frames allows visualization of object motion. FIG. 6 shows an effect of object motion correction algorithms. Image 610 shows a brightfield image of a threat scene, in this case a mixture of E. coli and BG spores. Image 620 shows a montage of uncorrected images, and image 630 shows an uncorrected average image containing the motion artifacts of object blurring. Motion correction may result in a much sharper average image, as shown in image 640. Frame-by-frame registration may be implemented for real-time motion correction according to an embodiment of the disclosure. Once an object is in the field of view and motion correction is turned on, effective object tracking may result as the algorithm works to maintain the object's position in the field of view over time which may be useful for running a subsequent spectral identification algorithm.

A second stage of the proposed MIGHTI sensing system may apply a spectral sensing modality that produces highly discriminating signatures. In one embodiment, the wide-field sensor may be a hyperspectral thermal IR imager, and the narrow-field sensor may be a Raman sensor.

In choosing a versatile and robust identification algorithm, trade-offs may be assessed as part of the algorithm's definition phase. The choice of which criteria will control in any given situation depends at least in part on sensor characteristics of the threats, backgrounds in the area to be analyzed, and signatures of expected or possible contaminants, to name a few. Table 1 indicates nonlimiting areas to consider when defining an identification algorithm:

| Area | Trade Space | Criteria | Comments |
|---|---|---|---|
| Algorithm | Classification vs. | Performance against | Classification may be |
| Type | Detection | P_{D}/P_{FA} | implemented as |
| | | | parallel detection. |
| Signal Model | Pure Pixel vs. Linear | Performance, sensor | LMM may be most |
| | Mixing Model | field of view relative | versatile. |
| | (“LMM”) vs. Stochastic | to threats | |
| | Mixing Model | | |
| Background | Structured vs. | Computational | May impact ability to |
| Model | Unstructured | requirements, clutter | suppress background. |
| | | suppression | |
| | | performance | |
| Detector Class | Likelihood Ratio Test | Ability to model/ | May not use LRT |
| | (“LRT”) vs. | simulate, | without knowledge of |
| | Generalized Likelihood | optimality | density parameters. |
| | Ratio Tests vs. others | | |
| Background | Libraries vs. Recent | Similarity of spectra, | May adapt library |
| Adaptation | Data | Signal to noise | based on some |
| | | (“SNR”) | weighting of recent |
| | | | data. |
| Spatial | Pixel Averaging vs. | Meet SNR for | Voting may be |
| Averaging | Voting on Single-Pixel | individual decisions, | claiming detection |
| | Decisions | Use voting to reduce | when number of |
| | | PFA | detected pixels |
| | | | exceeds a threshold. |

A two-stage sensing approach as disclosed in embodiments herein may offer fundamental advantages going into the identification stage, such as the targeted area under high magnification may be enriched in threat relative to interferents, and the high-resolution targeted area may allow even trace amounts of the threat to be resolved, in that threats are spread across multiple pixels. Thus, the approach may be less susceptible to background interference and a multi-pixel threat may make possible a second, voting algorithm applied to the outputs of the pixel-by-pixel algorithm decisions.

Threat identification may utilize descriptions of threat and background clutter (interferents) signatures in order to suppress clutter and assess the degree of match of the remaining spectral energy to the known threat signatures. An appropriate algorithm may depend in part on the degree of spectral variability in the signatures. One approach may be to describe the threat and clutter with subspaces and to provide for real-time adaptation of the background subspaces. An algorithm that applies the generalized likelihood ratio test (“GLRT”) to this type of signature representation is the Adaptive Subspace Detector (“ASD”). The GLRT may use maximum likelihood estimates of density parameters and may offer high Receiver Operating Characteristic (“ROC”) performance with practicality and predictability.

A key trade-off may be whether the clutter is best modeled as structured background, allowing the reduced dimensionality of a subspace, or modeled as unstructured, which may necessitate the use of a full covariance matrix. Structured backgrounds may be represented with a set of principal components numbering fewer than the original set of spectral channels, such as when there are interesting spectral regions that may not cover the full sensing spectrum and/or when the spectral resolution must be set to capture particular interesting features, conditions often existing in spectral sensing.

An advantage of using subspaces lies in the reduced computational burden, generally allowing much faster adaptation to changing backgrounds, which may be an important advantage in some scenarios. Threat signatures may often be best described by subspaces as well given the limited expected variability from the signature dependence on normal variations in biology and molecular arrangement.

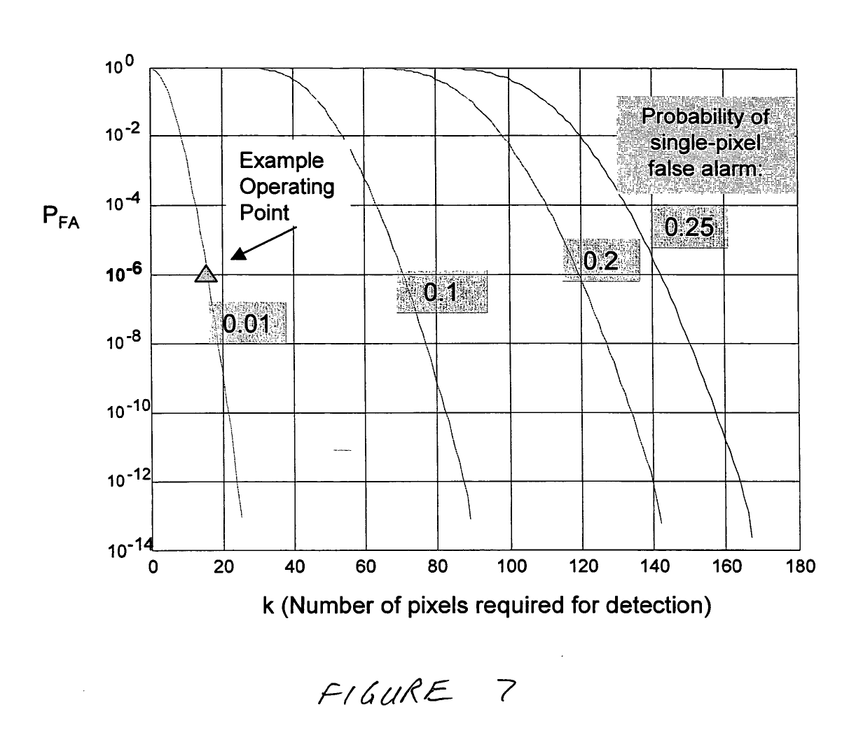

Embodiments of the present disclosure contemplate an improvement to the ASD by considering a voting algorithm that may be based on binomial statistics. The high-resolution imaging sensor may be sufficient to provide multi-pixel threats. Assuming each image pixel is an independent measurement, the overall P_{D} and P_{FA} values may be determined using a binomial distribution with the single-pixel P_{D} and P_{FA} values along with the number of image pixels. The overall P_{FA} value may be lower than the single-pixel P_{FA}. In essence, a threat may be declared to be present when enough pixels “vote” for the threat (i.e., by individual pixel detections). FIG. 7 is a graphical representation of the reduction of false alarm conditions due to the application of voting logic and imaging according to one embodiment of the disclosure. FIG. 7 illustrates the reduction in false alarms made possible with voting logic and imaging where the y-axis represents the probability of a false alarm (P_{FA}) and the x-axis represents the number of pixels required for detection in this nonlimiting example. In this example, with a 400-pixel image, an ASD single-pixel P_{FA} of 0.01, and a threshold on the number of required detections of 15, the P_{FA} can be reduced to 10⁻⁶ as seen in FIG. 7.

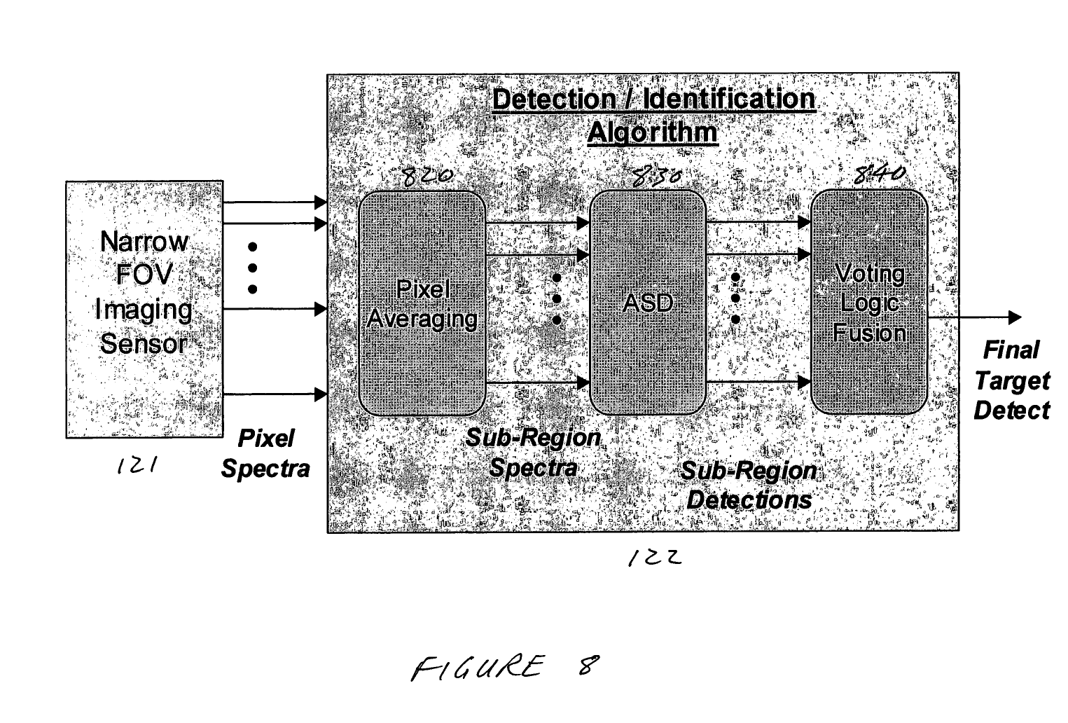

FIG. 8 is a block diagram illustrating the application of an identification algorithm according to one embodiment of the disclosure. FIG. 8 shows an identification algorithm flow diagram which may be applied to individual pixels and/or to sub-regions of a full image rather than individual pixels when the SNR in individual pixels is too low for direct application to the ASD algorithm. In FIG. 8, the detection/identification algorithm block 122 (as seen above in FIG. 1), may take inputs, which may be pixel spectra, from the narrow FOV imaging sensor 121 (also seen above in FIG. 1). The detection/identification algorithm 122 may operate on these inputs by performing pixel averaging in block 820. The output of block 820 may be input to the ASD block 830, where this input may be sub-region spectra. The output of block 830 may be input to the voting logic fusion block 840, where this input may be sub-region detections. The output of block 840 may be a detection of a contaminant in the target area.

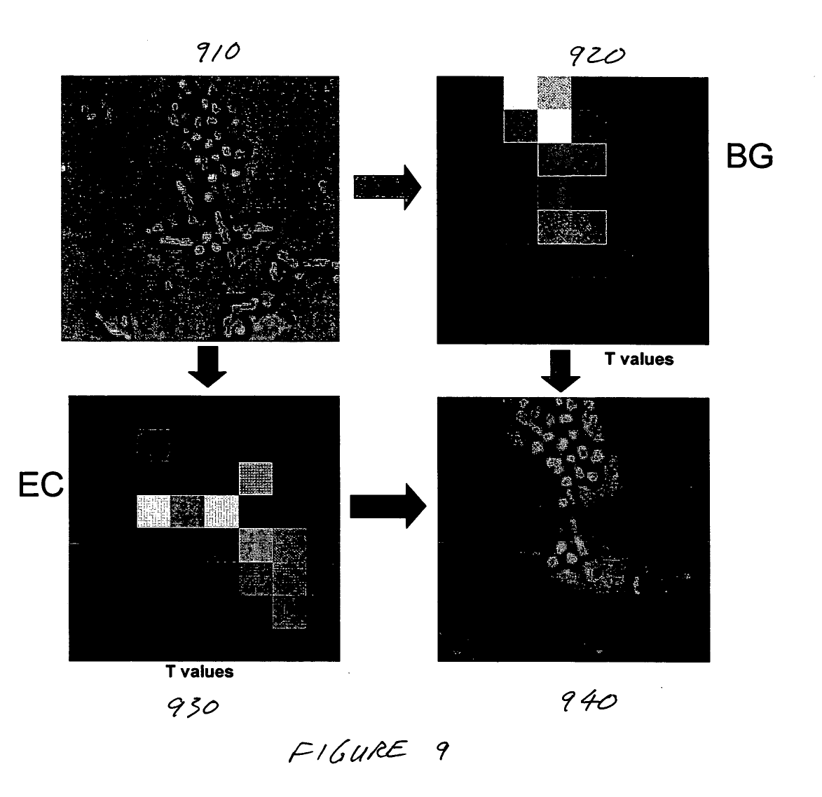

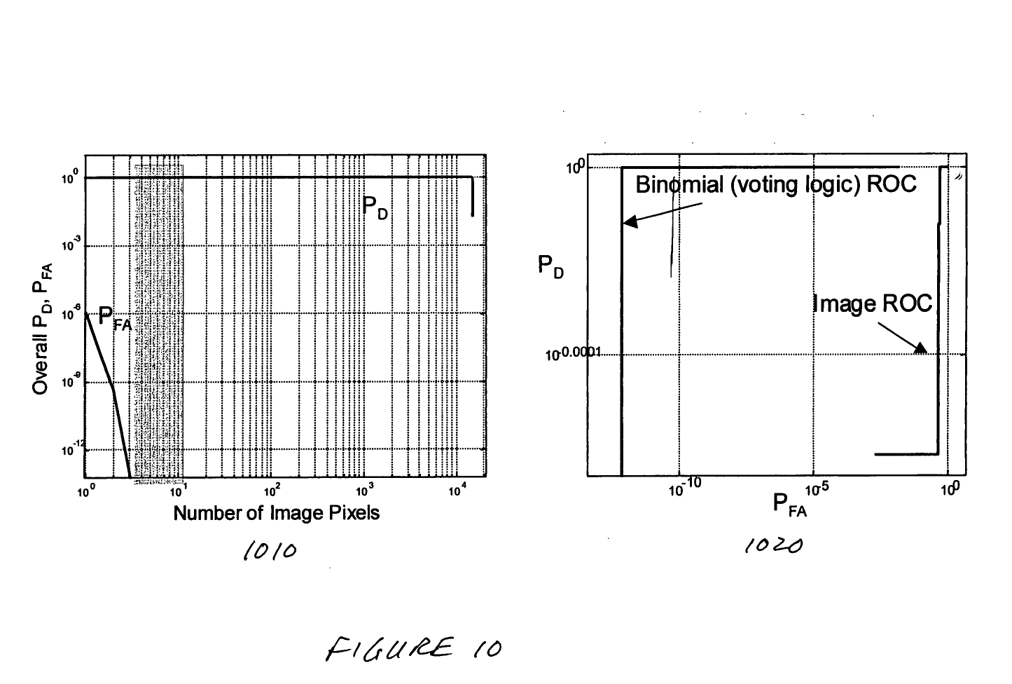

As a nonlimiting example, the effectiveness of ASD in a biothreat point detection scenario may be demonstrated by a test including acquiring a Raman hyperspectral image of a mixture sample comprised of threat stimulant BG and near-neighbor bacteria E. coli. The test requires an identification of BG amidst the E coli background. Dispersive Raman spectra were used in this example to create training subspaces for both BG and EC. The ASD algorithm may rely on a decision value T-statistic that is derived from a GLRT. The distributions of T-values may be used to characterize the background and threat subspaces. The T-values shown when testing for the EC and BG materials are shown separately in FIG. 9 as images 930 and 920, respectively. The image 910 is a brightfield image of the BG and EC coexisting in the scene. The smoothed ASD, when overlaid onto a brightfield image 910, results in the image 940 which shows the spatial distinction derived from the ASD. The BG spores, known a priori as the smaller round objects, are clearly highlighted relative to the more rod-like EC objects. Furthering this nonlimiting example, a voting logic routine may be applied to the ASD result found in the graph 310 in FIG. 3. In graph 310, the analytical ROC curve suggested a very clear distinction between MES and concrete. Purely for illustration, false positive pixels were generated by setting the operating point at a lower than optimal point which resulted in 5 false positive pixels out of the 14,960 image pixels, thereby giving an empirical P_{FA} of 3.4E⁻⁶. Applying the voting algorithm with this value, as shown in the graph 1010 of FIG. 10, indicates that the likelihood of more than 10 pixels being detected as false positives is 10⁻¹² small. Therefore, this results in the conclusion that if more than 10 threat pixels are detected in this image, the threat may be present. In the example discussed above, there were over 300 true positive pixels detected. One of ordinary skill in the art will readily understand that the foregoing is merely exemplary and will not limit the disclosure. As can be seen on the graph 1010, the overall P_{FA} is reduced sharply with threshold on number of required detections, without having an appreciable impact on P_{D}. As can be seen on the graph 1020, application of voting logic to the image described in the example above drastically improves ROC performance over that from the individual pixels. ROC curves were created from the voting logic P_{D} and P_{FA} curves and the detection image itself, as shown in the graph 1020. Voting logic ROC is improved relative to the empirical image ROC, indicting higher P_{D} and P_{FA} performance.

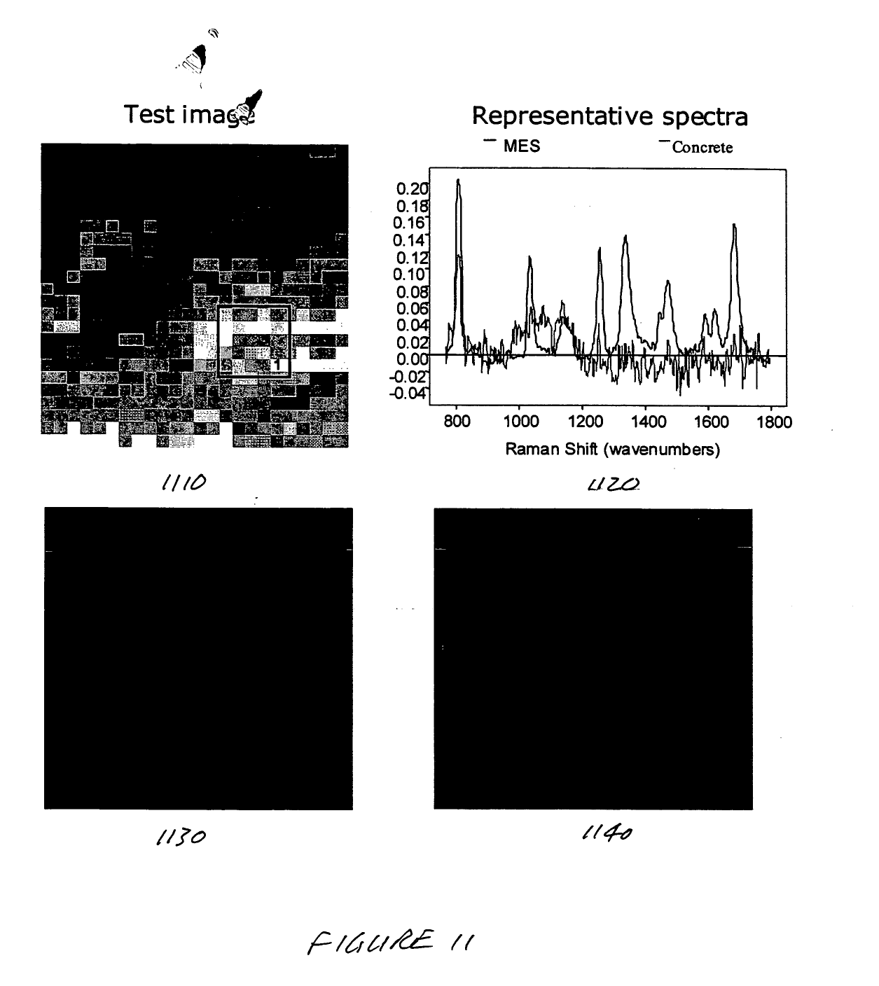

Embodiments of the current disclosure contemplate the use of various identification algorithms and are not limited to those described above. The ASD may be less useful when resolving components from mixture spectra. Multivariate Curve Resolution (“MCR”) is an iterative, pure component spectral resolution technique that may be more useful in certain situations. MCR may require a set of spectra representing estimates of the pure components in a particular hyperspectral image scene. MCR may then use an alternating least squares (“ALS”) approach with both concentration and spectral non-negativity constraints to determine the pure components and their relative concentrations in some of the pixels in the hyperspectral image. Upon convergence, the resulting spectra may represent pure component spectra. A nonlimiting example follows to demonstrate the effectiveness of MCR on hyperspectral data. A Raman hyperspectral image may be acquired of a high-magnification area of the chemical threat stimulant MES on a concrete background. Images 1110 and 1120 in FIG. 11 show an image frame at 1680 cm⁻¹ and the spectra corresponding to MES and a background region, respectively. The image 1130 shows the MCR detection image, and the image 1140 shows the MCR overlay on a brightfield image. The interface between MES and background is delineated, although the porosity of the concrete apparently allowed some MES to seep into the concrete. In this nonlimiting example, the MCR routine outperformed the ASD at unmixing and identifying MES. Other alternative candidate algorithms include, but are not limited to, matched filter detection, Constrained Energy Minimization (“CEM”), Orthogonal Subspace Projection (“OSP”), and Reed-Xu (“RX”) anomaly detection.

The above description is not intended and should not be construed to be limited to the examples given but should be granted the full breadth of protection afforded by the appended claims and equivalents thereto. Although the disclosure is described using illustrative embodiments provided herein, it should be understood that the principles of the disclosure are not limited thereto and may include modification thereto and permutations thereof.

1. A method for identifying threat agents, comprising the steps of:
scanning a threat area using a wide-field sensor attached to a moving object to thereby identify a location having a threat agent;
scanning the location using a narrow-field sensor attached to the moving object to thereby produce a signal;
providing the signal to an identification algorithm; and
identifying the threat agent using the identification algorithm.

2. The method of claim 1 further comprising the step of compensating for motion of the moving object.

3. The method of claim 1 wherein the identification algorithm comprises an adaptive subspace detection algorithm.

4. The method of claim 3 wherein said identification algorithm further comprises a voting algorithm.

5. The method of claim 1 wherein said identification algorithm comprises a morphological features algorithm.

6. The method of claim 1 wherein the scanning of the threat area includes:
scanning the threat area using the wide-field sensor to thereby generate a targeting signal;
processing the targeting signal using a targeting algorithm; and
configuring the targeting algorithm to identify said location having the threat agent.

7. The method of claim 6 wherein the configuring of the targeting algorithm includes training the targeting algorithm with at least one of a test threat agent, an interferent, and a background.

8. The method of claim 6 wherein the identification algorithm comprises an adaptive subspace detection algorithm.

9. The method of claim 8 including training the identification algorithm with at least one of a test threat agent, an interferent, and a background.

10. A system for identifying threat agents, comprising:
a first sensor attached to a moving object where said first sensor scans a threat area to thereby identify a location having a threat agent;
a second sensor attached to the moving object where said second sensor scans said location to thereby produce a signal; and
a processor programmed to run an identification algorithm, said processor receiving said signal and identifying said threat agent from said signal.

11. The system of claim 10 wherein said first sensor is a wide-field sensor.

12. The system of claim 11 wherein said wide-field sensor is selected from the group consisting of: an optical sensor, a fluorescence sensor, and a near infrared sensor.

13. The system of claim 10 wherein said second sensor is a narrow-field sensor.

14. The system of claim 13 wherein said narrow-field sensor is selected from the group consisting of: a Raman sensor and a near infrared sensor.

15. The system of claim 10 further comprising means for motion compensation.

16. The system of claim 15 wherein said means for motion compensation includes at least one of the following: an inertial sensor stabilization system and an image frame registration algorithm.

17. The system of claim 10 wherein said moving object is selected from the group consisting of: an unmanned vehicle, an aircraft, a ground vehicle, and a water borne vessel.

18. The system of claim 10 wherein said identification algorithm comprises an adaptive subspace detection algorithm.

19. The system of claim 18 wherein said identification algorithm further comprises a voting algorithm.

20. The system of claim 10 wherein said identification algorithm comprises a morphological features algorithm.

21. The system of claim 10 wherein said identification algorithm is selected from the group consisting of: Adaptive Subspace Algorithm, Multivariate Curve Resolution Algorithm, Constrained Energy Minimization Algorithm, Orthogonal Subspace Projection Algorithm, RX Anomaly Detection Algorithm, and Automated Anomaly Detection Algorithm.

22. The system of claim 10 wherein said threat area includes a volume in space containing an aerosol or a vapor cloud.

23. The system of claim 10 wherein said threat agent is selected from the group consisting of: biothreats, bacterial spores, live cells, virus, toxins, protozoan, protozoan cyst, and combinations thereof.

24. The system of claim 10 wherein said signal includes information representative of a narrow field of view image.

25. The system of claim 24 wherein said identification algorithm performs the following processes:
(a) pixel averaging;
(b) adaptive subspace detection; and
(c) voting logic.

26. A system for identifying threat agents, comprising:
a wide-field sensor attached to a motorized vehicle where said wide-field sensor scans a threat area to thereby identify a location having a threat agent;
a narrow-field sensor attached to the motorized vehicle where said narrow-field sensor scans said location to thereby produce a signal; and
a processor programmed to execute an identification algorithm to identify said threat agent from said signal, wherein said processor receives said signal and wherein said identification algorithm performs the following processes:
(a) pixel averaging;
(b) adaptive subspace detection; and
(c) voting logic.

27. The system of claim 26 wherein said wide-field sensor is selected from the group consisting of: an optical sensor, a fluorescence sensor, and a near infrared sensor.

28. The system of claim 26 wherein said narrow-field sensor is selected from the group consisting of a Raman sensor and a near infrared sensor.

29. The system of claim 26 further comprising means for motion compensation.

30. The system of claim 29 wherein said means for motion compensation includes at least one of the following: an inertial sensor stabilization system and an image from registration algorithm.

31. The system of claim 26 wherein said motorized vehicle is selected from the group consisting of: an unmanned vehicle, an aircraft, a ground vehicle, and a water-borne vessel.

32. The system of claim 26 wherein said identification algorithm comprises a morphological features algorithm.

33. The system of claim 26 wherein said identification algorithm includes an algorithm selected from the group consisting of: Adaptive Subspace Algorithm, Multivariate Curve Resolution Algorithm, Constrained Energy Minimization Algorithm, Orthogonal Subspace Projection Algorithm, RX Anomaly Detection Algorithm, and Automated Anomaly Detection Algorithm.

34. The system of claim 26 wherein said threat area includes a volume in space containing an aerosol or a vapor cloud.

35. The system of claim 26 wherein said threat agent is selected from the group consisting of: biothreat agents, bacterial spores, live cells, virus, toxins, protozoan, protozoan cyst, and combinations thereof.

36. A method for identifying threat agents, comprising the steps of:
scanning a threat area using a wide-field sensor attached to a motorized vehicle to thereby identify a location having a threat agent;
scanning said location using a narrow-field sensor attached to the motorized vehicle to thereby produce a signal; and
providing a processor programmed to execute an identification algorithm to identify said threat agent from said signal, wherein said processor receives said signal and wherein said identification algorithm performs the following processes:
(a) pixel averaging;
(b) adaptive subspace detection; and
(c) voting logic.

37. The method of claim 36 further comprising means for motion compensation.

38. The method of claim 37 wherein said means for motion compensation includes at least one of the following: an inertial sensor stabilization system and an image frame transfer registration algorithm.

39. The method of claim 36 wherein said identification algorithm comprise a morphological features algorithm.

40. The method of claim 36 wherein said identification algorithm, includes an algorithm selected from the group consisting of: Adaptive Subspace Algorithm, Multivariate Curve Resolution Algorithm, Constrained Energy Minimization Algorithm, Orthogonal Subspace Projection Algorithm, RX Anomaly Detection Algorithm, and Automated Anomaly Detection Algorithm.

41. The method of claim 36 wherein said threat area includes a volume in space containing an aerosol or a vapor cloud.

42. The method of claim 36 wherein said threat agent is selected from the group consisting of: biothreat agents, bacterial spores, live cells, virus, toxins, protozoan, protozoan cyst, and combinations thereof.

43. A method for identifying threat agents, comprising the steps of:
scanning a threat area using a wide-field sensor attached to a moving object to thereby identify a location having a threat agent;
scanning the location using a narrow-field sensor attached to the moving object to thereby produce a signal, wherein said narrow-field sensor comprises a Raman sensor;
providing the signal to an identification algorithm; and
identifying the threat agent using the identification algorithm.

44. The method of claim 43 further comprising the step of compensating for motion of the moving object wherein said compensation is achieved by at least one of: an inertial sensor stabilization system and an image frame registration algorithm.

45. The method of claim 43 wherein the identification algorithm comprises an algorithm selected from the group consisting of: an adaptive subspace detection algorithm, a voting algorithm, a morphological features algorithm, Adaptive Subspace Algorithm, Multivariate Curve Resolution Algorithm, Constrained Energy Minimization Algorithm, Orthogonal Subspace Projection Algorithm, RX Anomaly Detection Algorithm, Automated Anomaly Detection Algorithm, and combinations thereof.

46. The method of claim 43 wherein the scanning of the threat area includes: scanning the threat area using the wide-field sensor to thereby generate a targeting signal;
processing the targeting signal using a targeting algorithm; and
configuring the targeting algorithm to identify said location having the threat agent.

47. The method of claim 46 wherein the configuring of the targeting algorithm include training the targeting algorithm with at least one of a test threat agent, an interferent, and a background.

48. The method of claim 43 wherein said threat agent is selected from the group consisting of: biothreat agents, bacterial spores, live cells, virus, toxins, protozoan, protozoan cyst, and combinations thereof.

49. The method of claim 43 further comprising:
providing a processor programmed to execute an identification algorithm to identify said threat agent from said signal, wherein said processor receives said signal and wherein said identification algorithm performs the following processes:
(a) pixel averaging;
(b) adaptive subspace detection; and
(c) voting logic.

50. A system for identifying threat agents, comprising:
a wide-field sensor attached to a motorized vehicle where said wide-field sensor scans a threat agent to thereby identify a location having a threat agent;
a narrow-field sensor attached to said motorized vehicle where said narrow-field sensor scans said location to thereby produce a signal, wherein said narrow-field sensor comprises a Raman sensor; and
a processor programmed to execute an identification algorithm to identify a threat agent from said signal, wherein said processor receives said signal.

51. The system of claim 50 wherein said identification algorithm performs the following processes:
(a) pixel averaging;
(b) adaptive subspace detection; and
(c) voting logic.

52. The system of claim 50 wherein said wide-field sensor is selected from the group consisting of an optical sensor, a fluorescence sensor, and a near infrared sensor.

53. The system of claim 50 further comprising means for motion compensation wherein said means comprises at least one of: an inertial sensor stabilization system and an image frame registration algorithm.

54. The system of claim 50 wherein said identification algorithm includes an algorithm selected from the group consisting of: Adaptive Subspace Algorithm, Multivariate Curve Resolution Algorithm, Constrained Energy Minimization Algorithm, Orthogonal Subspace Projection Algorithm, RX Anomaly Detection Algorithm, Automated Anomaly Detection Algorithm, a morphological features algorithm, and combinations thereof.

55. The system of claim 50 wherein said threat agent is selected from the group consisting of: biothreat agents, bacterial spores, live cells, viruses, toxins, protozoan, protozoan cysts, and combinations thereof.
